(19) United States
(12) Patent Application Publication
(10) Pub. No.: US 2008/0228298 A1
(43) Pub. Date: Sep. 18, 2008

(54) PORTABLE MULTI-MEDIA DEVICE

(76) Inventors: Steven Rehkemper, Chicago, IL (US); Ryan Kratz, Oak Park, IL (US); Daniel Kim, Chicago, IL (US); Jackson Wilson, Evanston, IL (US); William Fu Man Hung, Kowloon (HK)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(21) Appl. No.: 11/937,627

(22) Filed: Nov. 9, 2007

Related U.S. Application Data
(60) Provisional application No. 60/865,019, filed on Nov. 9, 2006.

(51) Int. Cl. G06F 3/048; G06F 17/00

(52) U.S. Cl. 700/94; 715/772

(57) ABSTRACT

A portable multi-media device, preferably a hand held device used to capture digital images, digital video, and audio. The portable multi-media device comprising a sensor, operation members, an integral display, a speaker, a microphone, a memory card, and an integrated circuit. The portable multi-media device further has the capability to manipulate and edit data captured by the sensor and microphone and to organize and access the data based on user inputs. In addition to executing functions on the integral display, the device may also communicate with a personal computer or external display for interaction thereon.

### CROSS REFERENCE TO RELATED APPLICATIONS

The present application claims priority to U.S. Provisional Application Ser. 60/865,019 entitled “Portable Multi-media Device” filed on Nov. 9, 2006.

### FIELD OF THE INVENTION

The present invention relates to an interactive portable multi-media device, and in particular to a hand-held device for capturing and storing digital images, digital video and audio and further allows for the manipulation and edit of the digital images to create different types of outputs such as a slide show or a digital diary.

### BACKGROUND OF THE INVENTION

Cameras and systems for providing video recoding and playback are known in the art. Devices that incorporate these technologies may also combine aspects of digital cameras in that they allow the photographic capture of still digital images. However, the ability to relate digital images to separate audio files is not readily available. These devices, therefore have a continuing need for improvements or change in the interactive features the devices provide.

### SUMMARY OF THE INVENTION

In one embodiment of the present invention, there is provided a portable multimedia device capable of capturing and storing digital images and digital audio on a memory as digital image files and digital audio files accessible by a processor. The processor includes primary programming having executable code to assign a first file name to a digital image file being stored on the memory and also having executable code to assign a second file name to a digital audio file being stored on the memory. The digital audio file being stored is captured after the digital image file is stored on the memory and the second file name is associated with the first file name.

Further, the processor includes secondary programming having executable code to play back the digital image file assigned to the first file name on a display integral to the device and having executable code to search for the second file name associated with the first file name and executable code to simultaneously play back through a speaker integral to the device the digital audio file associated with the second file name.

The device also includes a plurality of operation members positioned for manipulation and having tertiary programming with executable code to play back the digital image file assigned to the first file name and having executable code to add text using the operation members to the digital image file to create an edited digital image file and executable code to save the edited digital image file to the memory. The device may also communicate with a PC, external memory and an external display via a various communication methods.

In another embodiment of the invention, the portable multimedia device may include programming having executable code to assign a unique file name to a digital image file being stored on the memory, such that a plurality of digital image files stored on the memory have separate unique file names. Further, the device may include executable code to associate a digital audio file being stored on the memory to a stored digital image file by assigning the digital audio file a file name corresponding to the unique file name associated to the stored digital image file. Where the digital audio file being stored on the memory is captured after the digital image file is stored, one or more of the digital image files stored on the memory are capable of having an associated digital audio file stored on the memory. Additionally, executable code may be included to play back one of more digital image files and when a digital audio file stored on the memory is associated with the one of the digital image files being played back, the executable code simultaneously plays back the associated digital audio file with the digital image file.

The device may also include a plurality of operation members positioned for manipulation and programming having executable code to play back a digital image file stored on the memory, executable code to add text to the digital image file by using the operation members to create a edited digital image file, and executable code to save the edited digital image file to the memory.

In this embodiment the device may further keep the saved edited digital image file assigned to the unique file name associated with the digital image prior to editing.

In another embodiment of the invention, an apparatus captures and stores digital images and digital audio on a memory as digital image files and digital audio files. The device includes at least one processor coupled to the memory where the processor assigns a first file name to a digital image file being stored on the memory and assigns a second file name to a digital audio file being stored on the memory when the digital audio file being stored is captured after the digital image file is stored on the memory. The processor associates the second file name to the first file name when the digital audio file corresponds to the digital image file. The processor then plays back the digital image file assigned to the first file name on a display integral to the device, searches for the second file name associated with the first file name and plays back through a speaker integral to the device the digital audio file associated with second file name.

In another embodiment of the invention, a processor coupled to the memory assigns a unique file name to a digital image file being stored on the memory, such that a plurality of digital image files stored on the memory have separate unique file names. The processor further associates a digital audio file being stored on the memory to a stored digital image file, of the plurality of digital image files, by assigning the digital audio file a file name corresponding to the unique file name associated to the stored digital image file. The digital audio file being stored on said memory is captured after the digital image file is stored, such that one or more of the digital image files stored on the memory are capable of having associated digital audio files stored on the memory. Further, the processor plays back one of more digital image files and when a digital image file being played is associated with a stored digital audio file, the processor plays back the digital audio file while said digital image file is played.

Additionally, the device may include a plurality of external operation members in communication with the processor(s) and the processor(s) may further play back a digital image file stored on the memory, add text to the digital image file in accordance to commands received from the operation members to create an edited digital image file, and save the edited digital image file to the memory.

Additionally, the device includes a method for substantial simultaneous play back of at least one digital image file and at least one digital audio file separately stored on a memory for use with or on a handhold multimedia device. The method associates a digital audio file to a digital image file stored on the memory. The digital audio file is then stored on the memory. The digital image file is loaded for play back on a display integral to the device and the digital audio file associated to the digital image file is identified and played along with the digital audio file. Further, the playing of the associated digital audio file and digital image file may occur substantially simultaneously. This method may also enable a user to edit the digital file in accordance with edit commands received during the playing of the digital image file and create an edited digital image file, which may then be stored.

Another method included in the device is a method for playing at least one digital image file and at least one digital audio file separately stored on a memory where the memory is coupled to a processor(s). In this method, the processor assigns a unique file name to a digital image file being stored on the memory, such that a plurality of digital image files stored on the memory have separate unique file names. Next, the digital audio file stored on the memory is associated with a corresponding digital image file by assigning a unique file name to the corresponding digital image file. The digital image file is then displayed while the associated digital audio file is played. Further, text may be added to the digital image file in accordance to commands received from a plurality of external operation members.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1 is a first illustrative view of the portable multi-media device;

FIG. 2 is a second illustrative view of the portable multi-media device;

FIG. 3A is a front view of the first embodiment of the portable multi-media device with a portion of the external housing removed;

FIG. 3B is a rear view of the first embodiment of the portable multi-media device with the a portion of the external housing removed;

FIG. 4 is an illustrative view of the portable multi-media device in communication with a personal computer;

FIG. 5 is an illustrative view of the portable multi-media device in communication with an external display;

FIG. 6 is a flow chart showing the steps of playing back a digital image file with a separately stored digital audio file in accordance to one embodiment of the present invention;

FIG. 7 is a block diagram of the portable multi-media device for an embodiment of the present invention; and

FIG. 8 is a flow chart showing the steps of playing back a digital image file with a separately stored digital audio file in accordance to another embodiment of the present invention.

### DETAILED DESCRIPTION OF THE EMBODIMENTS

While the invention is susceptible to embodiments in many different forms, there are shown in the drawings and will described herein, in detail, the preferred embodiments of the present invention. It should be understood, however, that the present disclosure is to be considered an exemplification of the principles of the invention and is not intended to limit the spirit or scope of the invention, claims, and/or embodiments illustrated.

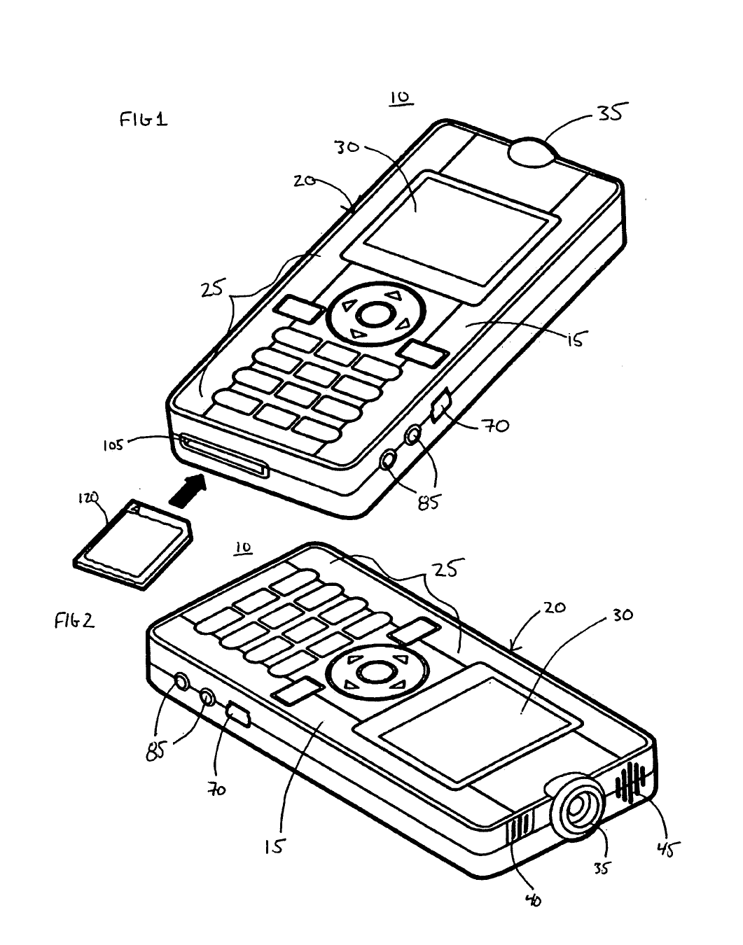

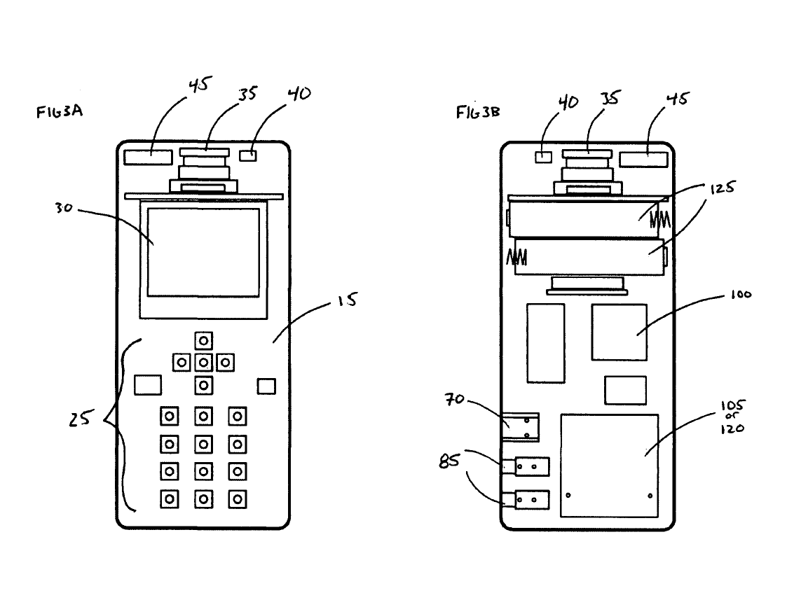

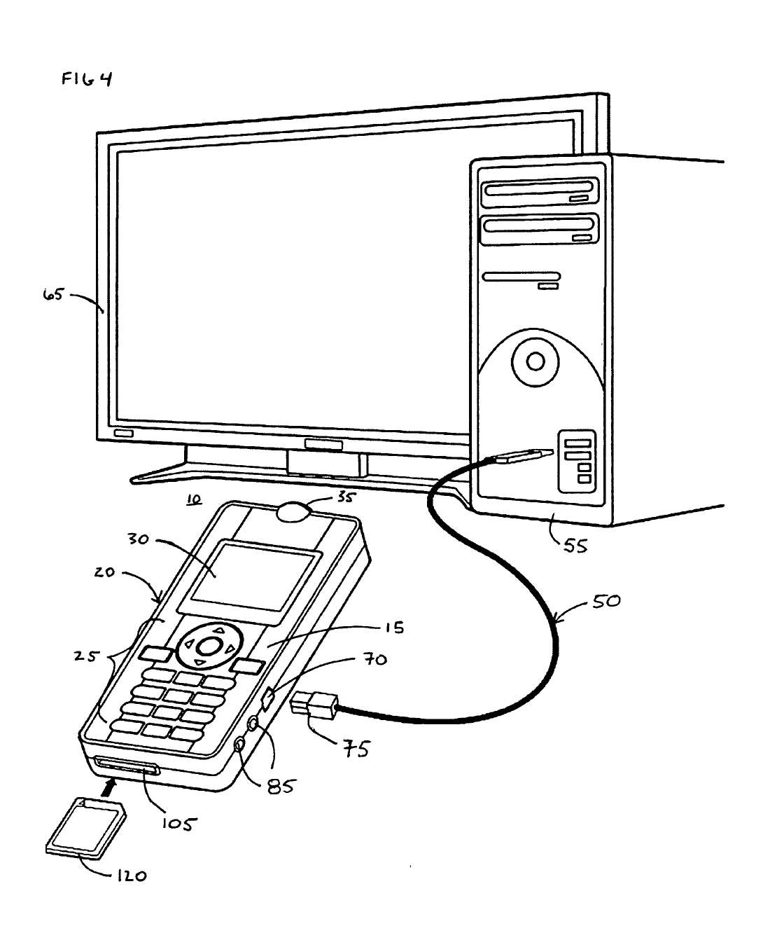

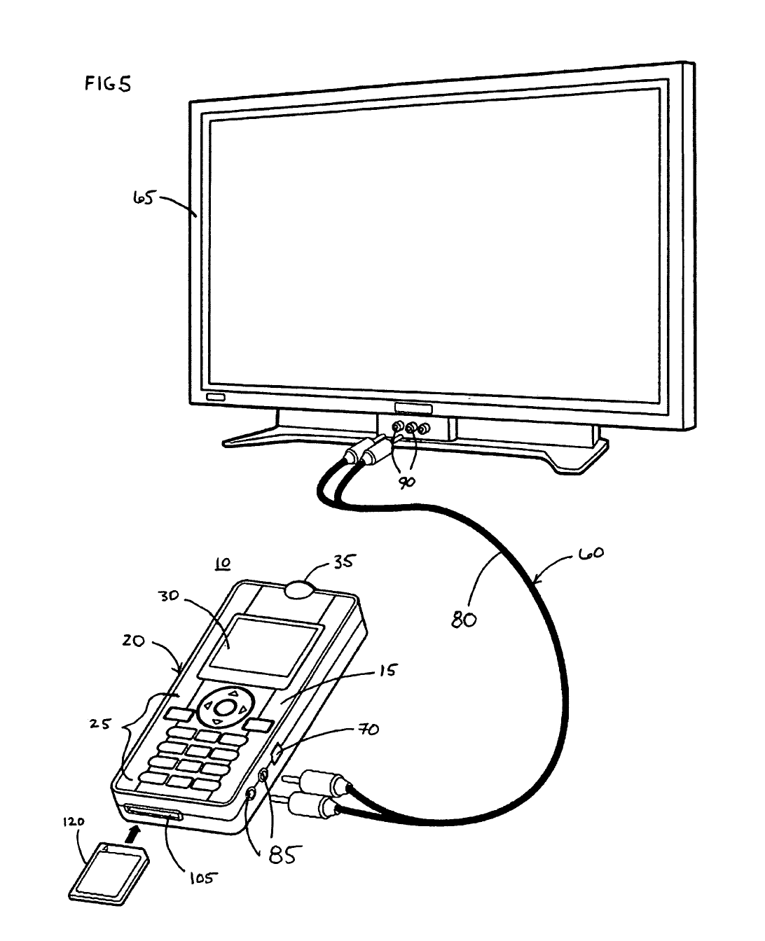

Referring now to FIGS. 1, 2, 3A and 3B, in accordance to a first embodiment there is illustrated a portable multi-media device 10 that may be defined as a hand-held body 15 that includes an external housing 20 and a plurality of operation members 25. The operation members 25 are positioned on the outside of the hand-held body 15 for external manipulation by a user. The hand-held body 15 further includes an integral display 30. The integral display 30 is a Liquid Crystal Display or LCD as commonly referred. The portable multi-media device may have any number of variable forms and may vary depending on the desired functionality.

The portable multi-media device 10 may perform several different interactive functions, such as capture, store, edit, access, and output several different types of data files including digital images, digital video, and audio. A sensor 35 is included in the hand-held body 15 for capturing digital images and digital video, and such are well known in the art. The digital images are stored as data and may be in any number of file formats, including jpeg, gif, tif, bmp, etc. (hereinafter referred to as image data). The digital video is stored as data and may be in any number of file formats, including mpg, mpeg, mp4, avi, etc (hereinafter referred to as video data). A microphone 40 is included in the hand-held body for capturing audio. The audio input is stored as data and may be in any number of file formats including mp3, wav, etc. (hereinafter referred to as audio data). The portable multi-media device 10 also includes a speaker 45 to output and play audio data. The image data, video data and audio data (collectively referred to as content or data files) are stored in a memory either internally or externally to the portable multi-media device 10. Either type of memory is in communication with a processor(s) included in an integrated circuit (IC) (described below). The type of content or data files captured, stored, played, or received by the portable multi-media device 10 does not limit the scope of the present invention.

The portable multi-media device 10 may capture content or data files for access, display, arid interaction on the integral display 30 or an external display or PC (as described below). In the present embodiments, the external display is shown as a television set, however, any monitor or device capable of displaying images and/or emitting sound may be utilized as a display for the embodiments disclosed herein. A user may edit and manipulate the content or data files in a variety of capacities, such as adding text to captured image data, altering image data, and adding audio data as an output along with image data. Audio data may be captured after the capturing of the image or video data for association with or to the image data or video data, or associated thereto when the image data is accessed at a later time on the integral display 30 or an external display or PC.

To facilitate these functions, a user edits and manipulates the content or data files via the operation members 25 to enable simultaneous output of multiple data files. Per a user's designation, the processor(s) tags the individual data files in any number of conventions (such as a common number or filename) to identify and recognize a file as part of a simultaneous output (described in detail below). The files are then stored separately, but may be accessed by the processor(s) according to the common number or filename assigned for simultaneous output. For example, a simultaneous output may take image data and audio data and display the stored image data while the associated audio data is played.

An IC includes a processor(s) (described above and below) to access content or data files (such as image, video or audio data) stored on a memory internally or externally to the IC. The IC, amplifier, integral display, sensor, speaker and microphone (all described below), are in communication with a power source which provides power for activation and operation.

In one embodiment of the present invention, the processor(s) may include programming with executable code. The executable code would assign a first file name to a digital image file stored on the memory. The programming may also include executable code to assign a second file name to a digital audio file being stored on the memory, where the digital audio file being stored is captured after the digital image file is stored on the memory. The executable code would associate the second file name with the first file name. (In one instance the association could be to name the digital image file 0001.jpg and name the audio file 0001.wav. The association would then be part of the file name 0001.) The processor(s) may also include programming with executable code to play back the digital image file assigned to the first file name on a display integral to the device and have executable code to search for the second file name associated with the first file name and executable code to play back the digital audio file associated with the second file name via a speaker. The play back of the two files (digital image and digital audio) could be and is preferably substantially simultaneously. However, there could be a time delay in starting the playing of one file over the other file and such time delay could be entered or defined by the user.

Additionally, the processor(s) may have programming with executable code to play back the digital image file assigned to the first file name and having executable code to add text using the operation members to the digital image file to create an edited digital image file and executable code to save the edited digital image file to the memory (described in further detail below).

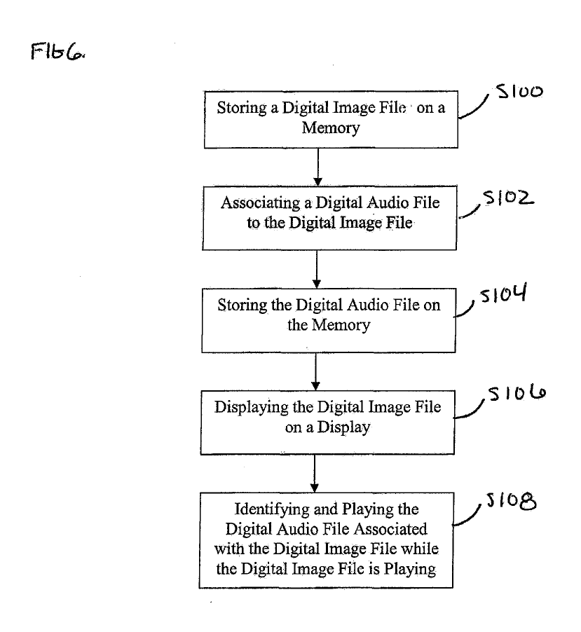

Referring now to FIGS. 4 and 5, in accordance to an embodiment, there is illustrated the portable multi-media device 10 with a first means to communicate 50 with a PC 55 or external memory (not shown) and/or a second means 60 to communicate with an external display 65.

The first communication means 50 is shown as a USB communication facilitated by well known USB components, such as a USB port 70 and a USB connector 75. The components needed to facilitate this mode of communication are widely available and known in the art, such that further reference is not needed. While not critical to the present invention, this USB communication enables the exchange of content and/or data files between the portable multi-media device 10 and a PC 55.

While again not critical to the present invention and further illustrated in FIG. 5, the second communication means 60 would include cables or wires 80 from output ports 85 on the portable multi-media device to input ports 90 on the external display 65. The wires 80 being removable as needed by the user. This second communication means 60 enables a user to display content and/or data files on the external display 65.

The IC 100 is also in communication with the power source 125 and an amplifier 130. From the processor(s) 95, audio signals are transferred to the speaker 45 via the amplifier 130.

The communication between the portable multi-media device 10 and external display or PC may also be a wireless communication facilitated by well known wireless components such as a transmitter/receiver (not shown). The components needed to facilitate this wireless mode of communication are widely available and known in the art, such that further reference is not needed.

In the first embodiment, the portable multi-media device 10 includes a means to capture content in the form of image data, video data and audio data and this content may be stored in a memory internally or externally to the portable multi-media device.

Further and in accordance with one or more of the embodiments described herein, the portable multi-media device 10 includes a means to simultaneously output image data, and audio data stored as separate files in an internal or external memory. This simultaneous output does not combine or compress different data files into one file (such as an mpeg), but rather synchronizes the access and output of the various data together for playback. By enabling simultaneous output (as described above and below), the simultaneous output of the data files may be accessed or viewed in a sequence determined by a user.

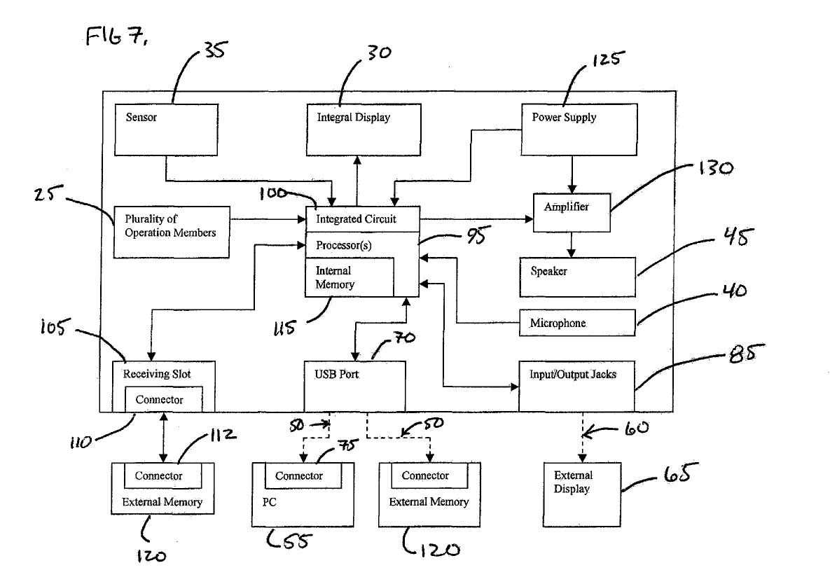

In another embodiment of the present invention there is provided a method for playing back at least one digital image file and at least one digital audio file separately stored on a memory used with or on a handheld multimedia device. The method is further described with reference to the flow chart in FIG. 6.

At step S100, a digital image file is stored on the memory. Collectively, these data files have been captured by the portable multimedia device 10 or have been transferred to the portable multimedia device 10 from an external source (further described below). Utilizing the operation members 25, a user directs the processor(s) to associate a digital audio file to a digital image file in step S102. If the digital audio file is already on the memory, the method will either link or rename the stored digital audio file to establish an association between the stored digital audio file to the digital image file or if the digital audio file has not been created, the method is setting up the link or name such that as soon as the digital audio is created the association is created. If the digital audio file has just been created, the digital audio file is then stored on the memory in step S104. At step S106, the digital image file is displayed on a display. The display may be integral or non-integral to the portable multimedia device 10. At step S108, the method identifies and plays the digital audio file associated with the digital image file while the digital image file is playing. The playing of the two files may be substantially simultaneously or one of the files may be delayed slightly but still played while the other is displayed or played.

One of more of the embodiments of the present invention also includes a means to organize and access image data, video data, and audio data and create electronically transferable data files when the data files are stored in the same location or different locations.

Additionally, one or more of the embodiments include a means to manipulate and edit captured image data and audio data on an integral display or a display non-integral to the portable multi-media device 10. Examples of the manipulation and editing capabilities include adding text to image data, blog entry, and creating user defined slide shows.

Also, one or more of the embodiments include a means to communicate with a PC wherein data files may be exchanged and software may be used to expand the capabilities of the portable multi-media device 10.

Further, one or more of the embodiments include a means to communicate with an external display, wherein stored data files may be displayed and manipulated at the direction of a user on the external display 65.

Additionally, one or more of the embodiments include a means to create a digital diary incorporating captured image data, video data, and audio data wherein such data may be manipulated and edited. Examples of the manipulation and editing of the data include adding text to image data. This digital diary may also incorporate existing content from external sources.

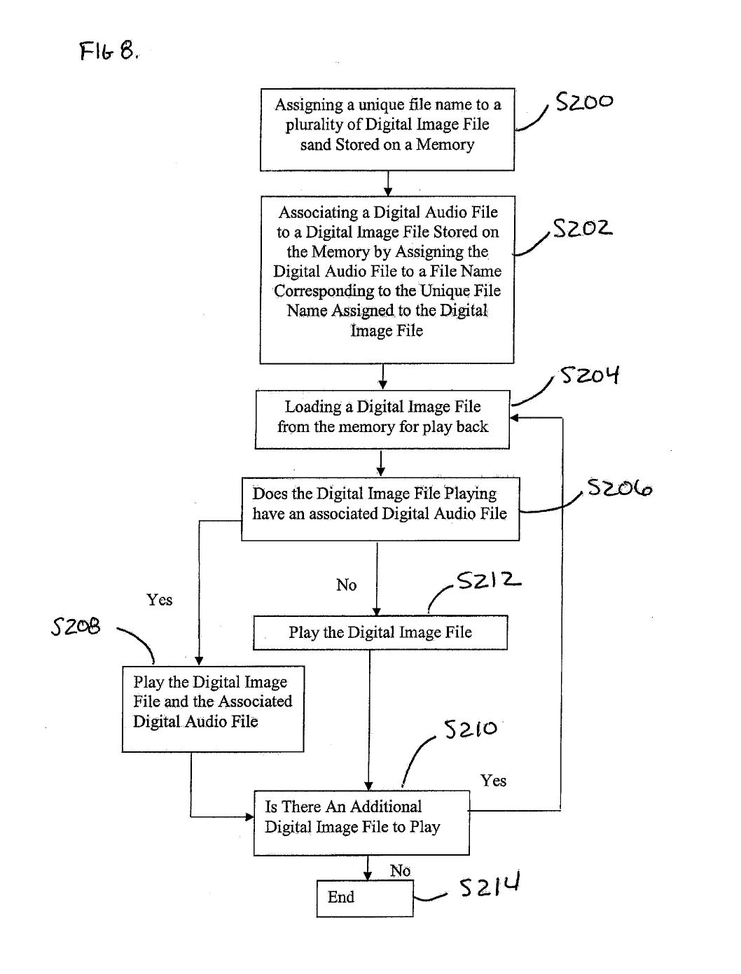

Referring now to FIG. 7, there is shown a block diagram provided especially for an embodiment of the portable multi-media device 10, however, its applicability for other embodiments would be apparent from its teachings. In this embodiment, a user utilizes the operation members 25 to operate the portable multi-media device 10. A sensor 35 captures digital images as image data or digital video as video data. As mentioned above, the data files may be in several different formats. The format of the image data and/or video data is not meant to limit the present invention. A processor(s) 95 included in the IC 100 receives the image data and/or video data from the sensor 35 via an electrical connection. Utilizing the electrical connection, content or data files (such as image data, audio data, video data, and/or generated signals, etc.) can travel between the processor(s) 95 and the various components of the portable multi-media device 10. As the image data and/or video data is captured by the sensor 35, a user also has the option to capture audio data utilizing a microphone 40 (further, a user also has the option to capture audio data at a later time as described below). The image data and audio data are then stored as separate files in an internal memory 115 or external memory 120. When the data is stored on an external memory 120, such as an external storage medium or SD card, the processor(s) 95 is in communication with a receiving slot 105 via an electrical connection. The receiving slot 105 includes a first connector 110 to operably connect with a second connector 112 included in an external memory 120. Various well known connectors to provide for an electrical connection and/or to provide the exchange of information and power may be used.

Further, the portable multi-media device may use a USB connection to facilitate communication with an external memory. With this type of connection, the processor is in communication with a USB port 70 via an electrical connection. The USB port 70 receives a USB connector 75 to communicate with an external memory 120, such as a USB flash drive. The components needed to facilitate this mode of communication are widely available and known in the art such that further reference is not needed. This USB communication enables the exchange of content or data files between the portable multi-media device 10 and the external memory 120.

In addition, data files may be stored internally in a memory 115 included in the IC 100. In both types of data storage, the image data and audio data may be kept separate and not combined into one file (such as an mpeg) as commonly practiced in the art. Rather, the processor(s) 95 organizes the data files so that they can be accessed for simultaneous output. As such, image data can be accessed and viewed with the desired audio data, without combining the data files. This simultaneous output of content or data files stored separately may utilize a less expensive processor because this type of action requires less computing power than the traditional compression of files. Further, the need to create a compressed third format (such as an mpeg) for viewing is eliminated since existing image data and audio data are used.

To facilitate this operation, the portable multimedia device 10 may include a method for playing at least one digital image file and at least one digital audio file separately stored on a memory where the memory is coupled to a least one processor. The method is further described with reference to the flow chart in FIG. 8.

At step S200, the method assigns unique file names to a plurality of digital image files stored on a memory, such that each digital image file has a different file name. Next, in step S202, the method associates a digital audio file to a digital image file stored on the memory by assigning the digital audio file to a file name corresponding to the unique file name assigned to the digital image file, which the user wants to associate. The digital audio file may then be stored on the memory with its corresponding association. At step S204, a digital image file, from the plurality of digital image files, is loaded from the memory. The method then determines whether the digital image file playing has an associated digital audio file in step S206. Alternatively, the method could determine if a digital audio file is associated with the digital image file. If yes, the digital image file and the associated digital audio file are played as shown in step S208. The method then determines whether there is an additional digital image file to play in step S201. This would happen, if a play back routine is set to play a plurality of digital images sequentially. If yes, the method reverts back to step S204 and continues as described above and below. If there is not an additional digital image file to play, the method ends at step S214. Referring back to step S206, if the digital image file playing does not have an associated digital audio file, the method plays the digital image file in step S212 and the program continues to step S210.

The portable multi-media device may also has the capability to edit image data. The processor(s) 95 first recognizes the format of the data and loads it into the memory 115 or external memory 120. Here, a user may edit the image data displayed on the integral display 30 via the operation members 25. For example, the image data may be altered and text may be added directly to the image data via the operation members. Once the image data has been manipulated or altered by a user, the processor(s) 95 will then save and store the data file back in the proper format and location.

One illustrative interactive example is described in the following digital diary example. A user may use the sensor 35 to capture several different digital images throughout a day. The processor(s) 95 directs these digital images to be saved as image data in separate files in a memory 115 included in the IC 100. This saved image data may be accessed while in transit or at a later time for viewing on the integral display 30 (or a PC 55 or an external display 65 as described above). In either situation, the user has the option to create a digital diary of their day utilizing the operation members 25 by creating a series of outputs of digital files and digital audio. By speaking a series of phrases into the microphone 40, audio is captured as audio data. The processor(s) 95 directs this audio to be saved as audio data in a separate file in the memory 115 included in the IC 100 (or stored externally as described above). Further, text may be added to the image data. The processor(s) 95 will then save the new image data in the memory 115. Based on the user's input, the processor(s) 95 will assign the audio data with a common identification tag (such as a number or filename) that relates to or is associated with the image date tag. During play back the processor(s) 95 will be directed to locate common or related tags, numbers or filenames such that the related files are played together. This may include a substantial simultaneous output. The user may add additional data files to create a sequence for simultaneous output as desired. The end result may be a sequential description of the user's day with their own digital pictures, voice recordings and text that may be viewed in any number of ways, such as a slide show complete with audio and text on the integral display 30, the PC 55 or a external display 65.

There is a virtually unlimited amount of interactive outputs that a user may create. The example above is meant to be but one of the many and is not meant to limit the invention in any manner.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred.

We claim:

1. A portable multimedia device capable of capturing and storing digital images and digital audio on a memory as digital image files and digital audio files accessible by a processor, said device further comprising:
primary programming on said processor, the primary programming having executable code to assign a first file name to a digital image file being stored on said memory, said primary programming also having executable code to assign a second file name to a digital audio file being stored on said memory, wherein the digital audio file being stored is captured after the digital image file is stored on said memory and wherein the second file name is associated with the first file name; and
secondary programming on said processor, the secondary programming having executable code to play back the digital image file assigned to the first file name on a display integral to the device and having executable code to search for the second file name associate with the first file name and executable code to simultaneously play back through a speaker integral to the device the digital audio file associated with second file name.

2. The device of claim 2, further including a plurality of operation members positioned for manipulation and having tertiary programming with executable code to play back the digital image file assigned to the first file name and having executable code to add text using the operation members to the digital image file to create a edited digital image file and executable code to save the edited digital image file to said memory.

3. The device of claim 2, wherein the saved edited digital image file remains assigned to the first file name.

4. The device of claim 1, wherein said device further includes a first means to communicate with a PC or external memory and/or a second means to communicate with an external display.

5. The device of claim 4, wherein said first means to communicate comprises a USB port and a USB connector to facilitate a USB connection with a PC to exchange data files and software such that data files may be viewed on said PC and software from said PC may be used to expand the capabilities of the device.

6. The device of claim 4, wherein said first means to communicate comprises a wireless transmitter/receiver defined by said device and a wireless transmitter/receiver defined on said PC to facilitate wireless communication to exchange data files and software such that data files may be viewed on said PC and software from said PC may be used to expand the capabilities of the device.

7. The device of claim 4, wherein said second means to communicate comprises input/output jacks to facilitate a wired connection with an external display to transfer data files from said device to said external display, such that said data files may be displayed and manipulated at the direction of a user on the external display.

8. A portable multimedia device capable of capturing and storing digital images and digital audio on a memory as digital image files and digital audio files accessible by a processor, said device further comprising:
programming on said processor, the programming having:
executable code to assign a unique file name to a digital image file being stored on said memory, such that a plurality of digital image files stored on said memory have separate unique file names;
executable code to associate a digital audio file being stored on said memory to a stored digital image file by assigning the digital audio file a file name corresponding to the unique file name associated to said stored digital image file, wherein the digital audio file being stored on said memory is captured after the digital image file is stored, such that one or more of the digital image files stored on said memory are capable of having associated therewith a digital audio files stored on said memory; and
executable code to play back one of more digital image files and when a digital audio file stored on said memory is associated with the one of the digital image files being played back, said executable code simultaneously plays back with the digital image file said associated digital audio file.

9. The device of claim 8, further including:
a plurality of operation members positioned for manipulation; and
the programming further having:
executable code to play back a digital image file stored on said memory,
executable code to add text to the digital image file by using the operation members to create a edited digital image file, and
executable code to save the edited digital image file to said memory.

10. The device of claim 9, wherein the saved edited digital image file remains assigned to the unique file name associated with the digital image prior to editing.

11. An apparatus that captures and stores digital images and digital audio on a memory as digital image files and digital audio files, comprising:
at least one processor coupled to said memory, said processor assigns a first file name to a digital image file being stored on said memory, and assigns a second file name to a digital audio file being stored on said memory, wherein the digital audio file being stored is captured after the digital image file is stored on said memory and wherein said processor associates the second file name to the first file name when the digital audio file corresponds to the digital image file, said processor plays back the digital image file assigned to the first file name on a display integral to the device, searches for the second file name associated with the first file name and plays back through a speaker integral to the device the digital audio file associated with second file name.

12. The apparatus of claim 11, wherein said processor plays back the digital audio file associated with the second file name substantially simultaneously with the play back of the digital image file.

13. An apparatus that captures and stores digital images and digital audio on a memory as digital image files and digital audio files, comprising:
at least one processor coupled to said memory, said at least one processor
assigns a unique file name to a digital image file being stored on said memory, such that a plurality of digital image files stored on said memory have separate unique file names,
associates a digital audio file being stored on said memory to a stored digital image file, of the plurality of digital image files, by assigning the digital audio file a file name corresponding to the unique file name associated to said stored digital image file, wherein the digital audio file being stored on said memory is captured after the digital image file is stored, such that one or more of the digital image files stored on said memory are capable of having associated therewith a digital audio files stored on said memory, and
plays back one of more digital image files, and wherein when a digital image file being played is associated with a stored digital audio file, the at least one processor plays back the digital audio file while said digital image file is played.

14. The device of claim 13, further including:
a plurality of external operation members in communication with the at least one processor; and the at least one processor further plays back a digital image file stored on said memory, adds text to the digital image file in accordance to commands received from the operation members to create an edited digital image file, and being capable of saving the edited digital image file to said memory.

15. A method for substantial simultaneous play back of at least one digital image file and at least one digital audio file separately stored on a memory for use with or on a handhold multimedia device, said method comprising:
associating a digital audio file to a digital image file stored on said memory;
storing said digital audio file on said memory;
loading a digital image file, of the at least one digital image file, for play back on a display integral to the device; and
identifying a digital audio file associated to said digital image file, and playing said digital audio file during the playing of the digital image file.

16. The method of claim 15, wherein playing said associated digital audio file during the playing of said digital image file occurs substantially simultaneously.

17. The method of claim 15 further comprising:
displaying a digital image file on said display;
editing the digital image file in accordance with edit commands received during the playing of the digital image file and creating an edited digital image file; and
storing the edited digital image file.

18. The method of claim 17 wherein, the association of the digital audio file to the digital image file is maintained during an editing of the digital image file such that the digital audio file becomes associated with the stored edited digital image file.

19. A method for playing at least one digital image file and at least one digital audio file separately stored on a memory, the memory coupled to at least one processor, said method comprising:
assigning a unique file name to a digital image file being stored on said memory, such that a plurality of digital image files stored on said memory have separate unique file names;
associating a digital audio file stored on said memory to a corresponding digital image file, of the plurality of digital image files stored on said memory, by assigning said digital audio file to a file name corresponding to the unique file name assigned to said corresponding digital image file;
displaying a digital image file, of the plurality of digital image files; and
playing an associated digital audio file while the digital image file is being displayed, when said digital image file being displayed has an associated digital audio file.

20. The method of claim 19, wherein the displaying of a digital image file and the playing of an associated digital audio file occurs substantially simultaneously.

21. The method of claim 19 further comprising:
displaying a digital image file stored on said memory;
adding text to said digital image file in accordance to commands received from a plurality of external operation members;
creating an edited digital image file of said digital image file with said added text; and
storing said edited digital image file.

22. The method of claim 21, wherein the association of the digital audio file to the digital image file is maintained when adding text to said digital image file such that the digital audio file becomes associated with the edited digital image file.
